(19) United States
(12) Patent Application Publication
(10) Pub. No.: US 2009/0054160 A1
(43) Pub. Date: Feb. 26, 2009

(54) Multiplayer Gaming Machine

(75) Inventor: Hiroki SAITO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/193,323

(22) Filed: Aug. 18, 2008

(30) Foreign Application Priority Data
Aug. 22, 2007 (JP) JP2007-215676

(51) Int. Cl. A63F 13/00

(52) U.S. Cl. 463/46

(57) ABSTRACT

A gaming machine is provided, which includes a main display and a plurality of terminals in a playing area. The plurality of terminals is situated in front of the main display, and arranged along both sides of an aisle. A terminal includes a seat having a backrest, an opening, a seat enclosure, and a sub display. The opening is formed at one side of the terminal so as to allow the player to move between the aisle and the seat. The seat enclosure surrounds the seat except for the side having the opening. The sub display is provided at a forward portion relative to the terminal on the seat enclosure. The seat is rotatable in a range from a first position where the backrest faces the opening to a second position where the backrest faces the main display.

This application is based on and claims the benefit of priority from Japanese Patent Application No. 2007-215676, filed on 22 Aug. 2007, the content of which is incorporated herein by reference.

### BACKGROUND OF THE INVENTION

1. Field of the Invention

The present invention relates to a multiplayer gaming machine.

2. Related Art

Conventionally, multiplayer gaming machines for commercial use, commonly referred to as gaming machines for mass entertainment (mass gaming machine), have been known. In recent years, there has been a horse-racing game machine as one example of such mass gaming machines. Such a mass gaming machine includes, for example, a main portion to which a large main display is attached and a plurality of terminals that is attached to the main portion, each having a sub display (for example, U.S. Patent Application No. 2007/0123354).

The plurality of terminals is placed in a playing area of a rectangular shape so as to face the main display. A space between an adjacent pair of terminals is used as an aisle. A seat in which a player is seated is provided at each of the plurality of terminals. The abovementioned sub display is provided at the front of the seat or at the diagonally forward right or left of the seat so that the player can visually recognize the sub display while the player is seated in the seat. This allows the player seated in the seat to visually recognize the sub display as well as the main display.

As the number of players to participate in a game increases, the number of partners and competitors increases accordingly. This results in an improvement of the game in terms of amusement. In addition, since the increase also allows the number of games to be played a day to augment, it contributes to an increase of the availability of a mass gaming machine.

As an example to implement the advantages described above, there is an idea that the width of the aisle is adapted to be narrow so as to increase the number of terminals placed in the playing area. However, the narrowed width of the aisle may cause players to physically come in contact with each other when they pass each other in the aisle between the terminals.

In order to solve the drawback described above it is, for example, proposed that the distance between a seat and a sub display is arranged to be small so as to implement a compact terminal such that the number of terminals placed in the playing area is increased.

### SUMMARY OF THE INVENTION

However, the small distance between the seat and the sub display as described above may cause legs of a player to be in contact with the sub display when the player sits on or leaves the seat, which may cause the player inconvenience.

The present invention has an object of providing a gaming machine which can increase entertainment of a game.

In addition, the present invention has an object of providing a gaming machine including a terminal which can decrease the distance between a seat and a sub display while allowing a player to sit on and leave the seat comfortably.

In an aspect of the present invention, a gaming machine is provided, which includes a main display and a plurality of terminals in a playing area. The main display displays an image related to a game. The plurality of terminals is situated in front of the main display, and arranged along both sides of an aisle. A terminal includes a seat, an opening, a seat enclosure, and a sub display. The seat has a backrest for supporting a back of a player. The opening is formed at one side of the terminal so as to allow the player to move between the aisle and the seat. The seat enclosure surrounds the seat except for the side having the opening. The sub display displays an image related to a game, and is provided at a forward portion relative to the terminal on the seat enclosure. The seat is rotatable in a range from a first position where the backrest faces the opening to a second position where the backrest faces the main display.

When a player takes a seat, the player rotates the seat to the first position where the backrest faces the opening and sits down on the seat. Subsequently, the player rotates the seat to the second position where the backrest faces the main display. With this operation, the player is free of physical interruption caused by the seat. In this way, the player can comfortably sit on the seat.

Accordingly, the player can be smoothly ready for a game, so that the player starts the game feeling good.

When the player leaves the seat, the player rotates the seat back to the first position where the backrest faces the opening and stands up from the seat. With this operation, the player is free of physical interruption caused by the seat. In this way, the player can comfortably leave the seat.

Compared with an unrotatable seat, the seat described above allows the player to more comfortably sit on and leaves the seat even if the distance between the seat and the sub display is reduced. In other words, it is possible to reduce the distance between the seat and the sub display while maintaining the comfortableness of the player associated with sitting on and leaving the seat.

In another aspect of the present invention, a gaming machine is provided, which further includes a driving device, an input device, and a controller. The driving device rotationally drives the seat. The input device accepts an input from a player. The controller controls the driving device in response to the input accepted by the input device.

With the gaming machine described above, it is possible for the player to much more comfortably sit on and leave the seat by using the input device.

The present invention can provide a gaming machine including a terminal which can save the distance between a seat and a sub display while allowing a player comfortably sit on or leave the seat.

### BRIEF DESCRIPTION OF THE DRAWINGS

FIG. 1 is a perspective view showing an external appearance of a terminal according to an embodiment of the present invention;

FIG. 2 is a perspective view showing the terminal in a rotated position relative to what is shown in FIG. 1;

FIG. 3 is a top view showing an external appearance of the terminal;

FIG. 4 is a side view showing an external appearance of the terminal;

FIG. 5 is a perspective view showing an external appearance of a gaming machine including a plurality of terminals;

FIG. 6 is a block diagram showing a configuration of a main control unit that is included in a main gaming unit;

FIG. 7 is a block diagram showing a configuration of a sub control unit that is included in a terminal; and

FIG. 8 is a flowchart showing a game operation of the gaming machine.

### DETAILED DESCRIPTION OF THE INVENTION

The embodiments of the present invention are hereinafter described in detail with reference to the attached drawings.

In the following descriptions, four directions with respect to a terminal are used: First to fourth directions represent a front direction, a back direction, and side directions perpendicular to the first and the second directions, respectively. The first/front direction is correlated with a longitudinal direction in which a player seated in a seat sees a main display.

A terminal 30 includes a backrest 312, a seat 31, an opening 32, a seat enclosure 33, and a sub display 34. The terminal 30 is surrounded by the seat enclosure 33 in three directions, and has the opening 32 in a fourth direction. The sub display 34 displays a game image, and is provided at a portion of the seat enclosure 33, which lies forward relative to the terminal 30. The seat 31 is rotatably supported by a leg portion 315 such that the backrest 312 can face the opening 32 and the front of the terminal 30.

The seat 31 includes a seating portion 311 on which a player sits, a backrest 312 for supporting a player's back, a headrest 313 provided at the top of the backrest 312, armrests 314 attached to both sides of the backrest 312, and a leg portion 315 attached to a base 35.

The seat 31 is movably supported by the leg portion 315. More specifically, a braking mechanism (not shown) for restricting rotation of the seat 31 is provided to the leg portion 315, and a rotation lever 316 is provided at a side close to the opening 32 on a bottom portion of the seating portion 311.

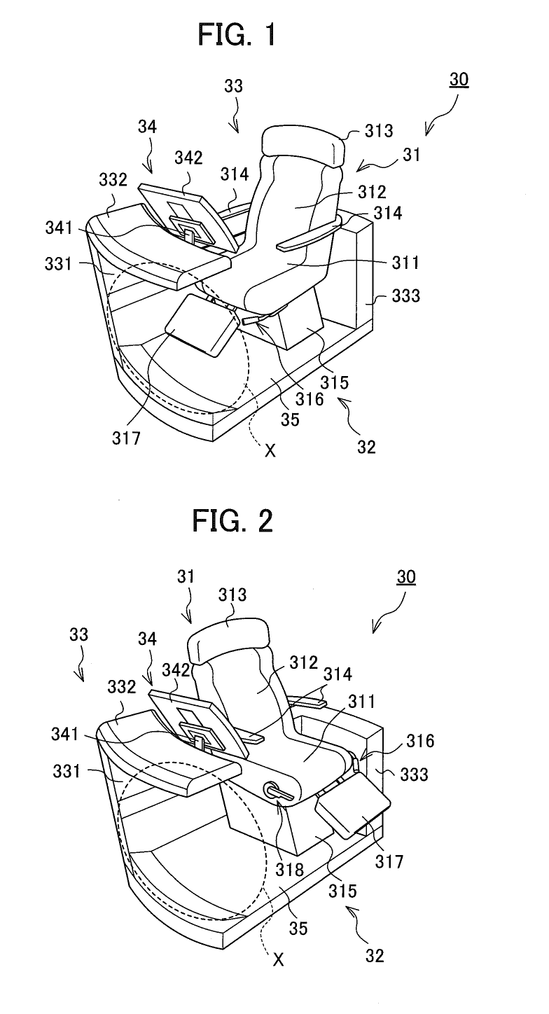

While the rotation lever 316 is not operated, the seat 31 is not rotated, for the seat 31 is fixed with respect to the leg portion 315 by means of the braking mechanism. On the other hand, while the rotation lever 316 is pulled upward, the seat 31, which is released from the braking mechanism, is rotatable with respect to the leg portion 315. Thus, while the rotation lever 316 is pulled upward, a player can rotate the seat 31 by applying a force with his/her leg against the base 35 in a circumferential direction about the leg portion 315 as an axis. In addition, the rotational angle of the seat 31 is restricted substantially up to 90 degrees, which corresponds to the movement between a position where the backrest 312 faces toward the front of the terminal 30 (shown in FIG. 1) and a position where the backrest 312 faces the opening 32 (shown in FIG. 2).

In addition, a leg rest 317 of variable angles with respect to the seating portion 311 is provided at the front of the seating portion 311. A leg lever 318 is provided at a side of the seating portion 311, opposite to the opening 32. While the leg lever 318 is not operated, the angle of the leg rest 317 is maintained. On the other hand, while the leg lever 318 is pulled upward, a player can change the angle of the leg rest 317.

The seat enclosure 33 includes a side unit 331 placed opposite to the opening 32, a front unit 332 provided at the front of the terminal 30, and a back unit 333 provided at the back of the terminal 30.

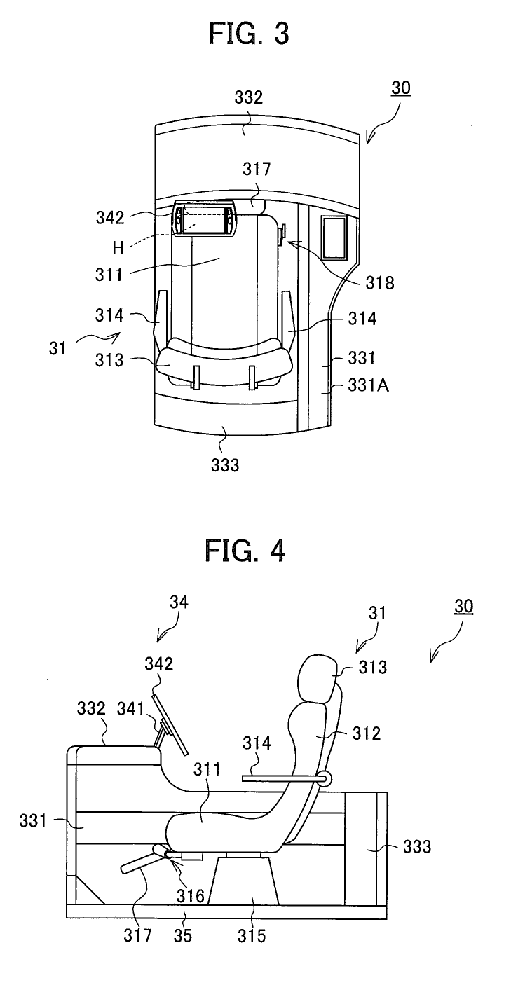

The side unit 331 extending vertically upward from the base 35 has a surface 331A (see FIG. 3) substantially horizontal with the base 35 at a position higher than the seating portion 311. A medal insertion slot and a medal discharging slot (not shown) are provided on the horizontal surface 331A.

The front unit 332 is a table having a surface substantially horizontal with the base 35 and is supported by a portion of the side unit 331 at the front of the terminal 30. The front unit 332 is provided at a position as high as a player's chest, and a space X below the front unit 332 can accommodate the player's legs while the player is seated on the seat 31.

The back unit 333 is integrally formed with the side unit 331.

As described above, three sides of the seat 31 are enclosed by the seat enclosure 33 including the side unit 331, the front unit 332, and the back unit 333. Accordingly, the player can sit on or leave the seat 31 only via the opening 32 where the seat enclosure 33 is not formed.

The sub display 34 includes an arm 341 supported by the front unit 332 and a rectangular liquid crystal monitor 342 attached at the end of the arm 341. The liquid crystal monitor 342 is a so-called touch panel and is provided at a position as high as the chest of a player seated on the seat 31.

With reference to FIG. 3, a part H of the seating portion 311 is hidden by the liquid crystal monitor 342 when the liquid crystal monitor 342 is viewed in a vertically upward direction. As shown in FIG. 4, the part H is located below the liquid crystal monitor 342. Accordingly, the liquid crystal monitor 342 and the seating portion 311 partially overlap each other in a horizontal direction, as viewed in a vertical direction.

Although the liquid crystal monitor 342 is composed of the touch panel in the present embodiment, the present invention is not limited thereto. Alternatively, an operation unit that allows a player to operate may be provided instead of the touch panel for the liquid crystal monitor 342.

When a player sits on the seat 31 of the terminal 30 described above, the player first operates the rotation lever 316 so as to rotate the seat 31 up to the position where the backrest 312 faces the opening 32, and then sits on the seat 31. Next, while continuing the operation of the rotation lever 316, the player rotates the seat 31 up to the position where the backrest 312 faces the front of the terminal 30. In other words, if the player rotates the seat 31, the legs of the player are guided into the space X below the front unit 332 so as to allow the player to be in an appropriate seated position. Since the liquid crystal monitor 342, which is partly located above the seating portion 311, and the front unit 332, to which the liquid crystal monitor 342 is attached via the arm 341, do not interfere with the sitting player, the player can sit on the seat 31 easily.

As a result, the player can start a game smoothly and enjoy more the game having entertainment properties.

In addition, when the player leaves the seat 31, the player rotates the seat up to the position where the backrest 312 faces the opening 32 while the player is seated on the seat 31. Then, the player rises from the seat 31. In other words, if the player rotates the seat 31, the legs of the player come out of the space X below the front unit 332. Therefore, since the liquid crystal monitor 342 and the front unit 332 do not interfere with the leaving player, the player can leave the seat 31 easily.

Accordingly, compared with the case of the seat 31 not rotatable, the player can sit on or leave the seat 31 more easily, even if the distance between the seat 31 and the liquid crystal monitor 342 is adapted to be smaller. Consequently, the distance between the seat 31 and the liquid crystal monitor 342 can be reduced while maintaining the advantage of allowing the player to comfortably sit on and leave the seat 31.

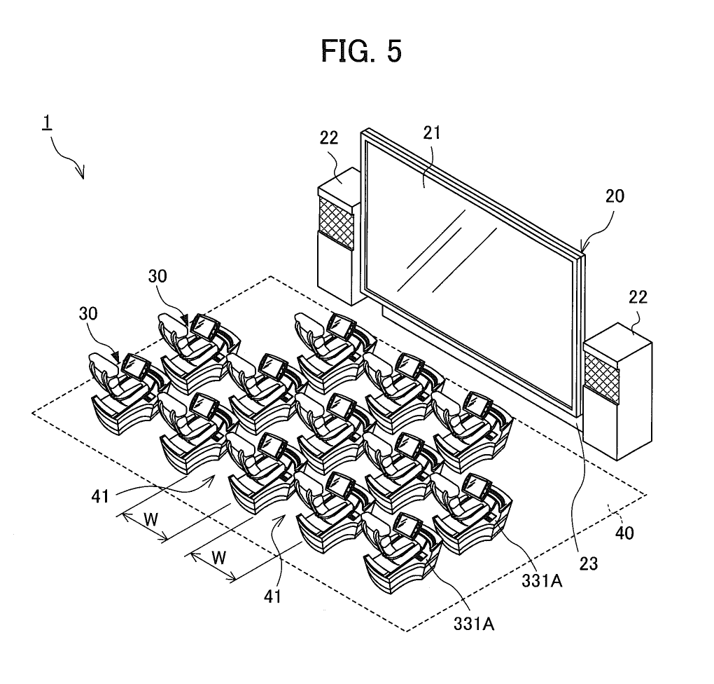

FIG. 5 is a perspective diagram showing the appearance of a gaming machine 1 including a plurality of terminals 30 described above. The gaming machine 1 is a multi-player game machine for performing a multi-player horse racing game in which many players participate, and includes a main gaming unit 20 having a large-sized main display 21 besides the plurality of terminals 30.

Besides the main display 21, the main gaming unit 20 includes speakers 22 disposed on both sides of the main display 21 and a main controller 23 for controlling the main display 21 and the speakers 22.

The main display 21 is a large-sized projector display. Controlled by the main controller 23, the main display 21 displays various images such as races performed by a plurality of horses and the results thereof. On the other hand, each terminal 30 has a sub display that displays information such as odds information for each horse and information related to bets placed by a player. Although a large-sized projector display is employed in the embodiment described above, the present invention is not limited to this type. Any type of large-sized monitor may also be employed.

The plurality of terminals 30, which is provided in front of the main display 21, is arranged along both sides of an aisle 41 with a width of W. An opening 32 of each terminal 30 is located in a particular direction that is consistently adopted for the plurality of terminals 30. Since two openings 32 of a pair of terminals 30 lying in parallel with each other do not face each other across the aisle 41, players playing a game at the pair of terminals 30 do not confront each other in the aisle 41 when the players simultaneously leave their seats 31. Accordingly, the present invention can reduce the width W of the aisle 41 more than an arrangement in which the openings 32 of the pair of terminals 30 face each other across the aisle 41.

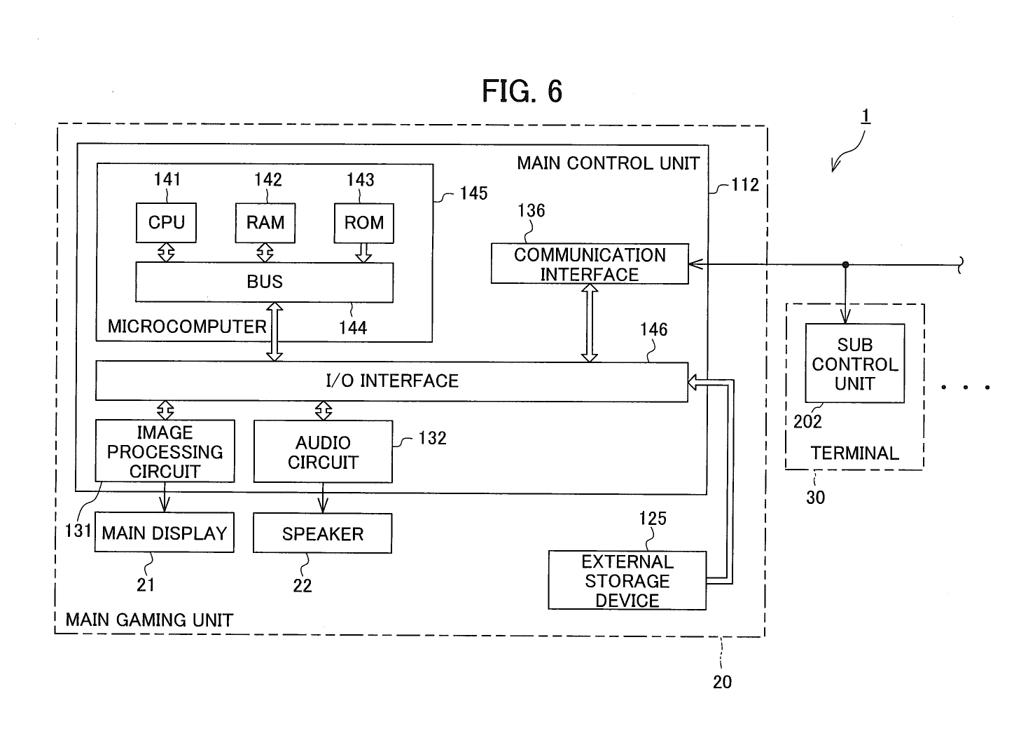

FIG. 6 is a block diagram showing a configuration of a main control unit 112 that is included in the main gaming unit 20. Basically, the main control unit 112 is composed of a microcomputer 145 as a core component, including a CPU 141, RAM 142, ROM 143, and a bus 144 for transferring data thereamong. The CPU 141 is connected with the RAM 142 and the ROM 143 via the bus 144. The RAM 142 is a memory for temporarily storing various data computed by the CPU 140. The ROM 143 stores various programs for executing processing required to control the gaming machine 1, a data table, and the like.

The microcomputer 145 is connected with an image processing circuit 131 via an I/O interface 146. The image processing circuit 131 is connected to the main display 21 and controls driving of the main display 21.

The image processing circuit 131 includes a program ROM, image ROM, image control CPU, working RAM, VDP (video display processor), video RAM, and the like (not shown). The program ROM stores an image control program related to a display in the main display 21 and various selection tables. In addition, the image ROM stores pixel data for creating an image to be displayed on the main display 21, for example. The image control CPU determines an image to be displayed on the main display 21, selecting from the pixel data according to the image control program that is called based on the parameters set by the microcomputer 145. The working RAM functions as a temporary storage device for executing the image control program by the image control CPU. In addition, the VDP is a component for creating image data corresponding to the display contents determined by the image control CPU, and for outputting the image data to the main display 21. It should be noted that the video RAM is configured as a temporary storage device used by the VDP for creating an image.

The microcomputer 145 is connected with an audio circuit 132 via the I/O interface 146. The audio circuit 132 is connected with the speakers 22. The speakers 22 produce various sound effects and BGMs for implementing various rendered effects, receiving a driving signal from the CPU 141, which is outputted by the audio circuit 132 to the speakers 22.

The microcomputer 145 is connected with an external storage device 125 via the I/O interface 146. The external storage device 125 functions similarly to the image ROM of the image processing circuit 131, in storing pixel data for creating an image on the main display 21, for example. Accordingly, when the image control CPU in the image processing circuit 131 determines an image to be displayed on the main display 21, it also takes into account the pixel data stored beforehand in the external storage device 125.

The microcomputer 145 is connected to a communication interface 136 via the I/O interface 146. The communication interface 136 is connected to a sub control unit 202 of each terminal 30. Thus, two-way communication can be performed between the CPU 141 and each terminal 30. The CPU 141 can transmit and receive instructions, requests, data, and the like between the CPU 141 and each terminal 30 via the communication interface 136. Accordingly, in the gaming machine 1, the main gaming unit 20 controls the flow of a horse racing game in cooperation with each terminal 30.

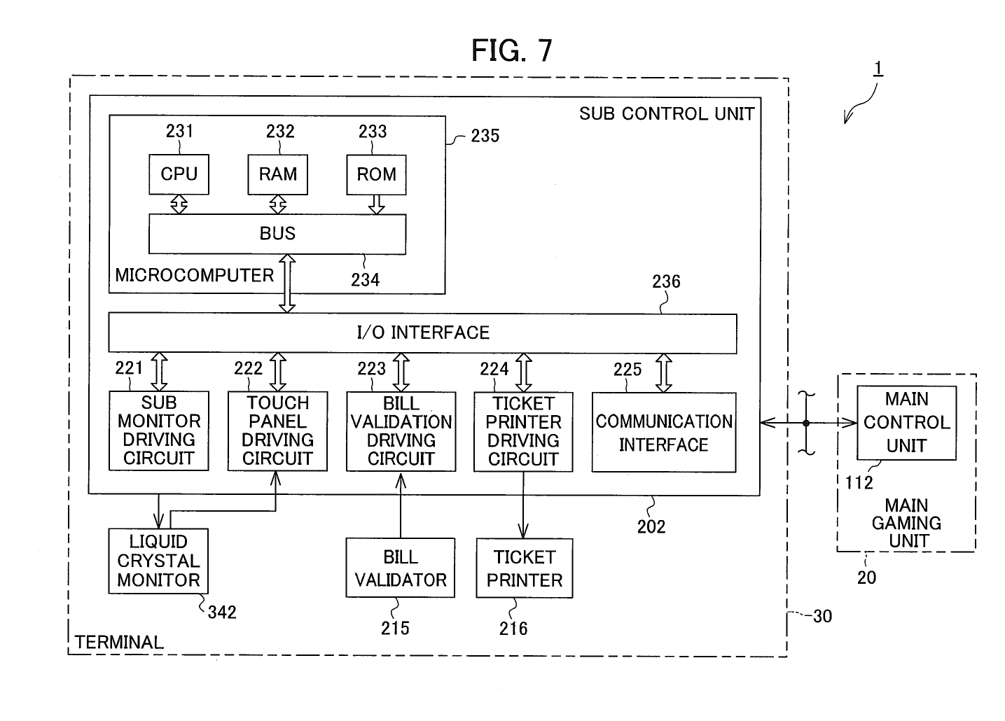

FIG. 7 is a block diagram showing a configuration of a sub control unit 202 that is included in each terminal 30. Basically, the sub control unit 202 is composed of a microcomputer 235 as a core component which includes a CPU 231, RAM 232, ROM 233, and bus 234 for transferring data thereamong. The CPU 231 is connected with the RAM 232 and the ROM 233 via the bus 234. The RAM 232 is a memory for temporarily storing various data computed by the CPU 231. The ROM 233 stores various programs for executing processing required to control the gaming machine 1, a data table, and the like.

The microcomputer 235 is connected to a sub monitor driving circuit 221 via an I/O interface 236. The sub monitor driving circuit 221 is connected with a liquid crystal monitor 342. The sub monitor driving circuit 221 controls driving of the liquid crystal monitor 342, receiving a driving signal from the main gaming unit 20.

The microcomputer 235 is connected to a touch panel driving circuit 222 via the I/O interface 236. The touch panel driving circuit 222 is connected to the liquid crystal monitor 342 serving as a touch panel. The microcomputer 235 inputs an instruction (a geometric position) to the CPU 231, which is given by a player through touching the liquid crystal monitor 342, receiving a corresponding coordinate signal sent from the touch panel driving circuit 222.

The microcomputer 235 is connected with a bill validation driving circuit 223 via the I/O interface 236. The bill validation driving circuit 223 is connected with a bill validator 215. The bill validator 215 discriminates authenticity of a bill or a ticket with a barcode. Upon reception of a valid bill, the bill validator 215 outputs an input signal related to the value of the bill to the CPU 231, receiving an identification signal from the bill validation driving circuit 223. In addition, upon reception of a valid ticket with a barcode, the bill validator 215 outputs an input signal related to a credit amount, etc. recorded on the ticket with a barcode to the CPU 231, receiving an identification signal from the bill validation driving circuit 223.

The microcomputer 235 is connected with a ticket printer driving circuit 224 via the I/O interface 236. The ticket printer driving circuit 224 is connected with a ticket printer 216. The ticket printer 216 outputs a ticket with a printed barcode that includes encoded data such as a credit amount stored in the RAN 232, receiving a driving signal from the CPU 231, which is sent by the ticket printer driving circuit 224 to the ticket printer 216.

The microcomputer 235 is connected with a communication interface 225 via the I/O interface 236. The communication interface 225 is connected with the main control unit 112 of the main gaming unit 20. Thus, two-way communication can be performed between the CPU 231 and the main control unit 112. The CPU 231 can transmit and receive instructions, requests, data, and the like between the CPU 231 and the main control unit 112 via the communication interface 225. Accordingly, in the gaming machine 1, each terminal 30 controls the flow of a horse racing game in cooperation with the main gaming unit 20.

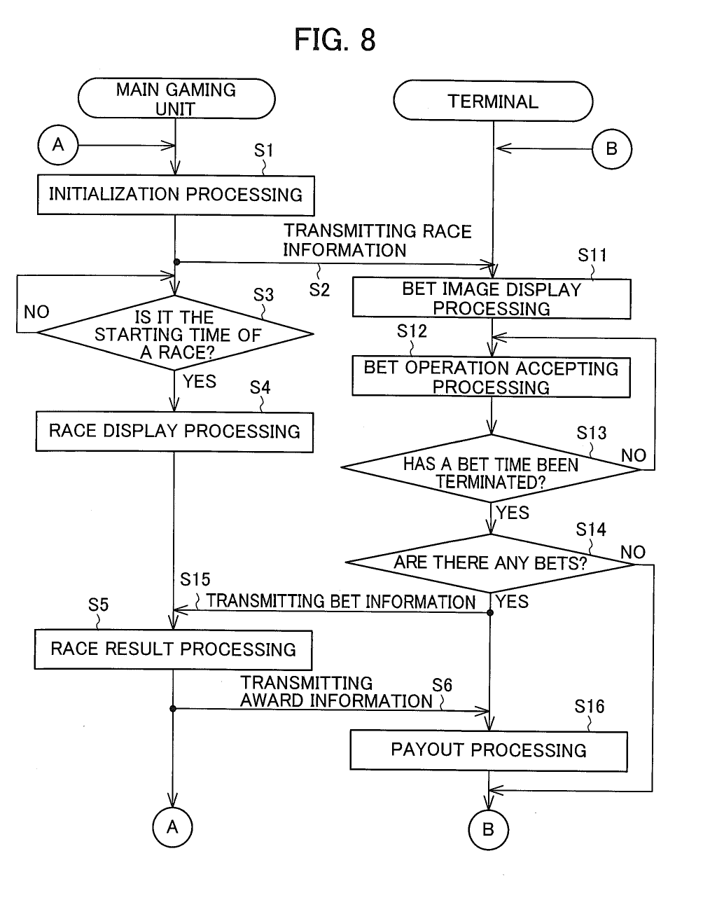

A game operation in the gaming machine 1 is described with reference to a flowchart shown in FIG. 8. Although the plurality of terminals 30 performs various game operations in cooperation with the main gaming unit 20, a description is given of only a typical terminal 30 as shown in FIG. 8.

The main gaming unit 20 performs operations in Step S1 to Step S6. In Step S1, the main control unit 112 performs initialization processing, and advances the processing to Step S2. In Step S1, the CPU 141 determines a course, starters, a starting time, and the like, of a horse racing game, and reads data related thereto from the ROM 143.

In Step S2, the main control unit 112 transmits race information to a terminal 30, and advances the processing to Step S3. In Step S2, the CPU 141 transmits data related to the course, the starters, the starting time, and the like, of the horse racing game to the terminal 30.

In Step S3, the main control unit 112 determines whether it is time to start the race. If YES in Step S3, the main control unit 112 advances the processing to Step S4. If NO in Step S3, the main control unit 112 repeats the processing of Step S3. More specifically, the CPU 141 repeats checking clock time until the starting time of the race arrives. When the starting time of the race arrives, the CPU 141 advances the processing to Step S4.

In Step S4, the main control unit 112 performs race display processing, and advances the processing to Step S5. In Step S4, the CPU 141 displays a race image on the main display 21 and produces sounds such as sound effects and voice from the speakers 22 based on the data read from the ROM 143 in Step S1.

In Step S5, the main control unit 112 performs race result processing, and advances the processing to Step S6. In Step S5, the CPU 141 calculates an award for the terminal 30 based on a race result and data related to BET information received from the terminal 30.

In Step S6, the main control unit 112 performs processing for transmitting award information, and returns the processing to Step S1. In Step S6, the CPU 141 transmits data related to the award for the terminal 30 calculated in Step S5.

On the other hand, the terminal 30 performs operations in Step S11 to Step S16. In Step S11, the sub controller 202 performs processing for displaying a BET image, and advances the processing to Step S12. In Step S11, the CPU 231 displays odds information, horse records, and the like, for each horse, on the liquid crystal monitor 342 based on the data transmitted from the main gaming unit 20 in Step S2.

In Step S12, the sub control unit 202 performs processing for accepting a BET operation, and advances the processing to Step S13. In Step S12, the CPU 231 causes a touch operation to be effective that is applied by a player to the liquid crystal monitor 342, and starts accepting a BET operation by the player, changing a display image according to the BET operation.

In Step S13, the sub control unit 202 determines whether a BET time has terminated. If YES in Step S13, the sub control unit 202 advances the processing to Step S14. On the other hand, if NO in Step S13, the sub control unit 202 repeats Step S13. More specifically, the CPU 231 checks time elapsed from the start of the processing for accepting BET operation in Step S12. When a predetermined period of time has elapsed, the CPU 231 terminates acceptance of a BET operation performed by a player, and advances the processing to Step S14.

In Step S14, the sub control unit 202 determines whether a BET operation has been performed. If YES in Step S14, the sub control unit 202 advances the processing to Step S15. On the other hand, if NO in Step S14, the sub control unit 202 returns the processing to Step S11. In Step S14, the CPU 231 determines whether a BET operation has been performed while the processing for accepting a BET operation is being performed.

In Step S15, the sub control unit 202 performs processing for transmitting BET information, and advances the processing to Step S16. In Step S15, the CPU 231 transmits data related to the BET operation to the main gaming unit 20.

In Step S16, the sub control 202 performs payout processing, and returns the processing to Step S11. In Step S16, the CPU 231 pays out medals from a medal discharging slot based on data related to the award transmitted from the main gaming unit 20 in Step S6.

As described above, the present invention can reduce the distance between the seat 31 and the liquid crystal monitor 342. Accordingly, it is possible to reduce a length in forward and backward directions of the terminal 30. In addition, since the present invention can reduce the width W of an aisle 41, it allows the number of terminals 30 placed in the playing area 40 to be increased.

In addition, a rotation button and a driving device for rotating the seat 31 may be adopted instead of the rotation lever 316 for the terminal 30 described in the above-mentioned embodiment. According to the alternative arrangement, a player operates the seat 31 as follows: When the player seated on the seat 31 operates the rotation button, the seat 31 is released from the braking mechanism to be rotated by the driving device up to a particular position where the backrest 312 faces the opening 32. Moreover, after a predetermined period of time has elapsed while the seat 31 is at rest at the particular position, it is rotated by the driving device up to a position where the backrest 312 faces the front of the terminal 30.

Alternatively, a weight sensor may be provided in the seating portion 311. With this configuration, it may be possible that when the weight sensor detects a weight more than a predetermined value while the seat 31 is at rest at the particular position with the backrest 312 facing the opening 32, the seat 31 is rotated up to the position where the backrest 312 faces the front of the terminal 30.

In addition, it may be alternatively possible that the weight sensor detects the weight of a player while the player is seated on the seat 31 and the weight is temporarily stored. With this arrangement, the operation of the seat 31 is performed in the following manner: If the player leaves the seat 31 while medals remain in the terminal 30 as credits, the seat 31 is rotated up to the position where the backrest 312 faces the front of the terminal 30 for a case where the weight sensor detects substantially the same weight as the weight of the player that has been stored temporarily. In this way, another player cannot occupy the seat 31 while the player is away from the seat 31 (for example, going to a restroom during a game).

The game medium is not restricted to coins in the present invention. In addition, examples of such game media include medals, tokens, electronic money or electronic value information (credits) having the same value.

Although embodiments of the present invention have been described, the present invention is not limited to the foregoing embodiments and includes modifications, improvements, and the like which achieve the objects of the present invention. Moreover, it should be understood that the advantages described in association with the embodiments are merely a listing of most preferred advantages, and that the advantages of the present invention are by no means restricted to those described in connection with the embodiments.

What is claimed is:

1. A gaming machine comprising:
a main display for displaying an image related to a game;
a plurality of terminals in a playing area that is situated in front of the main display, the plurality of terminals being arranged along both sides of an aisle,
wherein a terminal includes:
a seat having a backrest for supporting a back of a player;
an opening that is formed at one side of the terminal so as to allow the player to move between the aisle and the seat;
a seat enclosure for surrounding the seat except for the side having the opening;
a sub display for displaying an image related to a game, the sub display being provided at a forward portion relative to the terminal on the seat enclosure,
wherein the seat is rotatable in a range from a first position where the backrest faces the opening to a second position where the backrest faces the main display.

2. The gaming machine according to claim 1, further comprising:
a driving device for rotationally driving the seat;
an input device for accepting an input from a player; and
a controller that controls the driving device in response to the input accepted by the input device.
